(19) United States
(12) Patent Application Publication
(10) Pub. No.: US 2005/0047794 A1
(43) Pub. Date: Mar. 3, 2005

(54) Infrared remote control receiver and system

(76) Inventor: Felix Clarence Quintanar, Miami, FL (US)

Correspondence Address: LOTT & FRIEDLAND, P.A., P.O. BOX 141098, CORAL GABLES, FL, 33114-1098, US

(21) Appl. No.: 10/651,399

(22) Filed: Aug. 29, 2003

(51) Int. Cl. H04B 10/12

(52) U.S. Cl. 398/149

(57) ABSTRACT

The present invention provides an infrared remote control receiver with increased suppression of unwanted light, signals, or interference, specifically suppression of interference from plasma television displays and fluorescent light. The infrared remote control receiver may be used in remote control applications whereby it is connected between at least one remote control unit and at least one device or component that is intended to be operated. The receiver also contains status and infrared activity indicators, which indicate whether the individual components of the system are powered and whether the receiver is receiving an infrared signal. The receiver eliminates or reduces interference received by the receiver using a method of processing signals that changes the voltage reference level if the signal is determined to be noise and maintains the noise level at an established limit.

### FIELD OF INVENTION

This invention relates generally to the field of signaling devices and receivers for use in remote control applications, and in particular to an infrared receiver that has increased immunity to interference. This invention also relates to a method of processing signals by an infrared receiver.

### BACKGROUND OF THE INVENTION

This invention relates to an infrared receiver that has increased immunity to interference, in particular interference from plasma television displays and fluorescent light. Infrared rays are radiation at frequencies in the infrared region, between the highest radio frequencies and the lowest visible light frequencies. Infrared rays are commonly used in remote control applications because they are invisible to humans. The infrared rays used in remote controls are digitally encoded optical signals generated by light emitting diodes.

Remote controls may be employed in any large number of consumer electronic devices, such as televisions, VCR's, stereos, DVD players, home theater systems and even home security systems. Many companies make universal remotes, which control several pieces of equipment with one controller. Additionally, a few companies make remote systems, whereby several components or devices are connected together and controlled by a main network system or a total remote system. Such a system would have one or more universal remotes that could operate several pieces of equipment throughout a house or building. These total remote systems centrally and uniformly control the operation of a variety of devices over a variety of protocols within the network system.

There are some limits to infrared technology used in remote control applications. Generally, the technology is limited to line of sight applications, because small hand-held transmitters are incapable of producing sufficiently bright infrared beams to take advantage of reflection around comers. Also, infrared beams are generally too weak to effectively compete with sunlight in outdoor applications. Moreover, infrared receivers are susceptible to interference from infrared emission by plasma television displays and fluorescent light. Since plasma displays are increasing in popularity, there is a need in the technology for an infrared receiver that is immune from interference from plasma television displays, other types of plasma displays, and fluorescent light.

A system as described in U.S. Pat. No. 6,049,294 to Jae-Seok Cho discloses an adaptable receiving frequency selection apparatus and method of use for a remote controller. The control unit searches for external electromagnetic wave components existing within a carrier frequency range of the remote controller receiving module and selects another frequency range exclusive of the external electromagnetic wave components as a receiving frequency range. This system does not provide for high noise disturbance suppression, such as that from a plasma television, or the flexibility to be set up to receive a range of bandpass wavelengths depending upon the desired angle and range of use of the remote control. Additionally, this system does not provide status or activity indicators.

A system as described in U.S. Pat. No. 6,127,940 to Weinberg discloses an infrared secure remote controller. This system uses a remote controller with a xenon gas discharge tube with pulses or dark interval time being used by the circuitry of the receiver for the controller to identify and distinguish an actual transmission from other interfering transmissions. This system does not provide for high noise disturbance suppression, such as that from a plasma television display or fluorescent light.

One of the problems associated with current remote control network systems is that it is impossible to know the status of the components of the system and whether they are powered. Thus, a user may attempt to issue a command to a component via remote control, but the component is not able to respond to the command because the component is not powered. There is a need in the art for a status light, which may be a light emitting diode (“LED”), on the receiver to display to a user the status of each component.

Additionally, there is a need for current remote control network systems to indicate whether or not the desired receiver has received an infrared transmission. An indicator activity light would assist the user in knowing whether the system is receiving the infrared signal. The indicator activity light could also assist the installer of the system with quality control by confirming the system and the components are set up and functioning. Therefore, there is a need in the art for a remote control network system with an indicator activity light, which blinks as feedback to receiving infrared signals.

Consequently, there is a need in the art for an infrared remote control receiver with increased suppression of unwanted signals, specifically suppression of interference from plasma television displays and fluorescent light. There is also a need for a receiver that contains status and infrared activity indicators, which indicate whether the individual components of the system are powered and whether the receiver is receiving an infrared signal. Additionally, there is a need in the art for eliminating or reducing interference received by a receiver using a method of processing signals that changes the voltage reference level if the signal is determined to be noise and maintains the noise level at an established limit.

### SUMMARY OF THE INVENTION

The present invention solves significant problems in the art by providing an infrared remote control (“IRC”) receiver with improved discrimination and suppression of unwanted light, signals or interference, particularly interference from plasma television displays and fluorescent light. The infrared remote control receiver may be used in remote control applications whereby it is connected between at least one remote control unit and at least one device or component that is intended to be operated. The infrared remote control receiver has improved noise suppression and comprises an optional optical magnifier, an interference filter, at least one pin photodiode, an input amplifier, a microcontroller, an output amplifier, an output port and a power supply regulator. The receiving unit receives the transmitted remote control infrared modulated light signals and converts them into corresponding electrical modulated signals. The electrical signals are then compared by a microcontroller and output as an infrared light modulated signal using an external infrared emitter. The infrared light modulated signals that are output are sent to a device or component in order to operate that device or component in compliance with the finally identified control command. Additionally, the receiver will indicate activity and/or status of components attached to it.

The above and other objects of the invention are achieved in the embodiments described herein by incorporating a unique front end into the infrared remote control receiver. The unique front end comprises an optional lens, a bandpass glass interference filter, at least one pin photodiode, a high gain/high impedance input amplifier, a microcontroller and an output amplifier. The front end uses a microcontroller consisting of a comparator and a voltage reference to compare background noise with a possible infrared modulated transmission by using threshold control. If the microcontroller determines that the noise is background noise, the microcontroller suppresses the noise.

The present invention also includes methods of processing an infrared signal by an infrared remote control receiver. The receiver receives an infrared signal from a remote control, measures the background noise, determines if a signal is background noise or infrared signal, and changes the level of voltage reference if the signal is determined to be noise. The receiver system continuously repeats this process to suppress interference. The receiver also generates an indication of receipt of any infrared signal at an infrared activity indicator. Additionally, the receiver generates an indication of the status of each component within the receiver's system.

The infrared remote control receiver circuit consists of a series of amplifiers, at least one microcontroller, at least one status diode, an activity indicator diode, an input and output amplifier control. The software within the microcontroller compares the background noise with an infrared signal and if the signal is determined to be background noise, the microcontroller changes the voltage reference level. This circuit allows the receiver to differentiate background noise from an infrared signal and suppress background noise.

The infrared remote control receiver may be used in a system whereby at least one remote control operates at least one component. As such, the remote control will send an infrared signal to the infrared remote control receiver, which will then interpret the signal as noise or a command. If the signal is interpreted as a recognized command, the infrared remote control receiver will emit a corresponding infrared signal to the component or device. If the signal is interpreted to be noise, the infrared remote control receiver will suppress the signal and not emit a corresponding signal to the component or device. An advantage of the invention is that the infrared remote control receiver will not process interfering signals, such as those received from a plasma television. The infrared remote control receiver will identify such signals from a plasma television as interference and suppress them.

### BRIEF DESCRIPTION OF THE DRAWINGS

FIG. 1 is an overview of the IRC receiver according to the present invention.

FIG. 2 is an overview of the IRC receiver used in a signaling system.

FIGS. 3A-3C are schematic flow diagrams of a method of processing signals received by the IRC receiver.

FIG. 4 is a schematic circuit diagram of the IRC receiver according to the present invention.

### DETAILED DESCRIPTION OF THE PREFERRED EMBODIMENT

While the invention is susceptible of several embodiments, there is shown in the drawings, a specific embodiment thereof, with the understanding that the present disclosure is to be considered as an exemplification of the invention and is not intended to limit the invention to the specific embodiment.

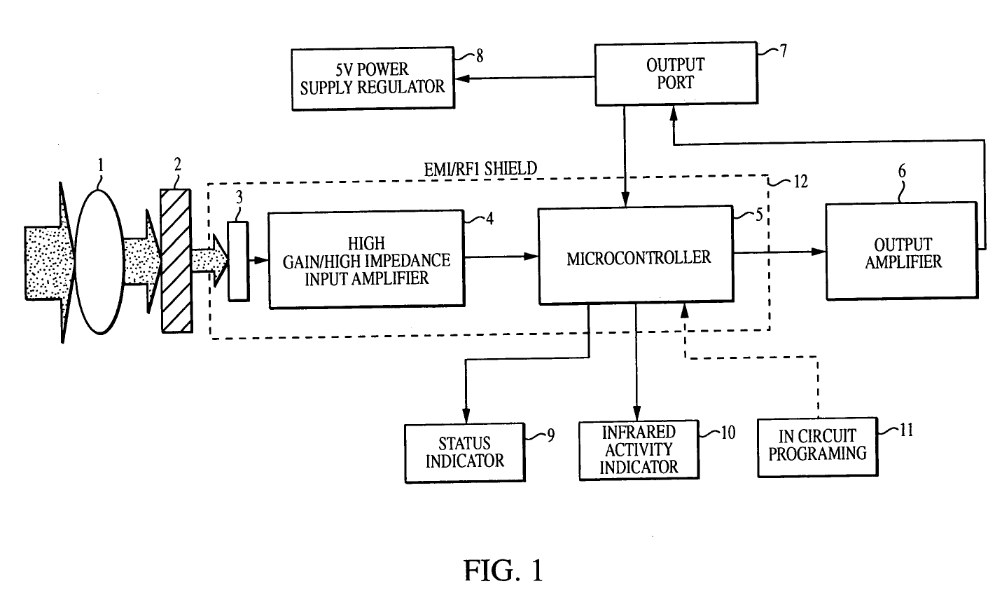

Referring initially to FIG. 1 of the drawings, in which like numerals indicate like elements throughout the several views, an overview of the infrared remote control receiver is shown. The IRC receiver converts modulated infrared light to an equivalent modulated electrical signal. A modulated infrared light can be regenerated at the output port 7 by means of an infrared light emitting diode (“LED”) emitter. Any infrared device using its remote will be able to be controlled through the infrared remote control receiver. The IRC receiver supports infrared light modulated with carrier frequencies from 20 kilohertz to 110 kilohertz keeping a maximum efficiency regarding with infrared code reception used in the market today. The IRC receiver also supports infrared light modulated without carrier frequencies and infrared light protocols without carriers.

The system optionally uses an optical magnifier 1 to collect and focus an emitted light source that is filtered through the optical interference filter 2 at the specific bandpass wavelength. The optical magnifier 1 can be any lens, preferably a planoconvex or fresnel lens. A planoconvex lens is usually flat on one side and convex on the other. A fresnel lens is usually a square, rather flat plastic lens with progressively thicker concentric areas. The lens may also be a sphere in order to capture the maximum amount of light possible. The lenses 1 increase the range of the reception angle from the remote control source. The lens 1 is optionally used in the system and depends on the desired wavelength or range for the particular application.

In order to spectrally match the majority of the remote control emitters, an optical glass interference filter 2 may be employed that allows the transmittance of greater than 80% of a specific bandpass wavelength. The receiving unit uses a glass interference filter 2 designed to transmit a band of frequencies with negligible loss while rejecting all other frequencies. The specific bandpass wavelength is variable depending on the number of pin photodiodes 3 used and the angle of the lens or optical magnifier 1. Thus, the specific bandpass wavelength may be modified to allow for maximum performance in different surroundings, for example, the specific bandpass wavelength may be modified to accommodate longer than average ranges or wider then usual angles. The specific bandpass wavelength can be made to range from about 950+/−12.5 nanometers to about 950+/−20 nanometers. The interference filter 2 permits the discrimination and suppression of unwanted light radiation. from sunlight, fluorescent light, plasma television displays, compact fluorescent lamps and any noise source that radiates out of the selected range of 950+/−Δ nanometers. The interference filter 2 is made up of a substrate and a film coating the substrate. Typically, the substrate is coated with a series of layers of differing materials having various properties, e.g., indices of refraction, producing interference effects achieving the desired wavelength transmission spectrum.

The receiver permits the discrimination and suppression of unwanted light or signals by using at least one high speed and high sensitive pin photodiode 3 with a radiant sensitive area of about 7.5 square millimeters spectrally matched to the integrated circuit of the infrared emitters on gallium arsenide (“GaAs”) or gallium arsenide with a mixture of gallium aluminum and gallium arsenide (“GaAs/GaAlAs”). The radiant sensitive area may be increased by the use of additional pin photodiodes 3. The pin photodiodes 3 are light-sensitive diodes usable as a photoconductive cell. Pin photodiodes 3 are used to capture light and increase the gain of the signal. Additional pin photodiodes 3 may be used when the specific bandpass wavelength is adjusted. The function of the pin photodiodes 3 is to receive infrared light signals from a remote control and convert them into corresponding electric signals.

This IRC receiver has an input amplifier 4 with high impedance and an overall high gain for amplifying very low input electric signals coming from a pin photodiode 3 with an infrared carrier frequency from about 20 kilohertz to 110 kilohertz. Preferably, the gain is around a magnitude of 100,000 or more. The gain is a single stage gain in order to derive less noise. The amplified signal is then fed to a microcontroller 5 for processing. The photodiode 3, the high gain, high impedance input amplifier 4 and the microcontroller 5 can be enclosed within an electromagnetic interference/radio-frequency interference (“EMI/RFI”) shield 12. The EMI/RFI shield 12 is made of magnetic material and encloses a magnetic component. The magnetic flux generated by the input amplifier 4 and the microcontroller 5 is confined by the shield thus preventing interference with external components. Likewise, external magnetic fields are prevented from reaching the enclosed components. When the EMI/RFI shield 12 is used in the receiver, the optical magnifier lens 1 may optionally be removed from the receiver. Additionally, when the EMI/RFI shield 12 encloses the photodiode 3, there are holes in the EMI/RFI shield 12 in front of the photodiode 3 to allow light to pass through the EMI/RFI shield 12 to the photodiode 3.

The microcontroller 5 processes the signal received from the input amplifier 4 with a microprocessor. The microprocessor is typically a single-chip computer element containing the control unit, central processing circuitry, and arithmetic and logic functions and is suitable for use as the central processing unit of a microcontroller 5. The preferred microprocessor is an 8 bit/8 pins flash based complementary metal-oxide semiconductor (“CMOS”). The microprocessor has an on-chip analogy comparator peripheral module and on-chip voltage reference that compares the background noise with possible infrared modulated transmissions. The comparator is an integrated circuit operational amplifier whose halves are well balanced and without hysteresis and therefore suitable for circuits in which two electrical quantities are compared. The microcontroller 5 uses threshold control, as opposed to gain control, which is more commonly used in microcontrollers. The use of threshold control allows the receiver to more accurately depict the infrared modulated transmission when the microcontroller 5 recreates the infrared signal. The microcontroller 5 receives in circuit programming 11, which serves to identify recognized signals.

Just outside the EMI/RFI shield 12, if it is employed, is the output amplifier 6. The output amplifier 6 may be a metal-oxide-silicon field-effect transistor (“MOSFET”). The output amplifier 6 receives the recreated signal from the microprocessor's comparator, amplifies it and sends it to the output port 7. The output port 7 regenerates a modulated infrared light signal by means of a light emitting diode. The regenerated infrared light signal is sent to the device or component intended to be controlled.

The circuit may use two different voltages; 12 volts externally regulated and an internal 5 volts regulated supply. The 12 volts supply is for the input/output amplifiers and the 5 volts supply is for the microcontroller. The exact voltage used depends on the various features employed by each system. The 5V power supply regulator 8 regulates the power for the microcontroller 5. The 5V power supply regulator 8 holds the power at a constant value. The circuit of the invention can be made on a printed circuit board (“PCB”), which is usually a copper-clad plastic board used to make a printed circuit. Preferably, the materials are made of R4 fiberglass. When the PCB is cut it is desirable to cover the cut edges with a metal cover, so as to reduce the noise that may be derived from the cut.

The front end of the infrared remote control receiver consists of an optional optical magnifier 1, an interference filter 2, one or more pin photodiodes 3, an input amplifier 4, a microcontroller 5 and an output amplifier 6. Typically, the front end of a receiver represents the converter portion of the superheterodyne receiver. The optical magnifier 1 may be a lens, the interference filter 2 may be a bandpass glass interference filter and the input amplifier 4 may be a high impedance and an overall high gain amplifier. The circuitry of the front end of this invention is novel to IRC receiver technology and the methods typically used to capture a signal. The IRC receiver provides for improved discrimination and suppression of unwanted light, signals or interference, particularly from plasma television displays and fluorescent light.

The voltage reference level is controlled and changed dynamically by software, which continuously measures the background noise appearing in the output of the comparator. Based on the duration of the noise, the implemented software defines if the signal is indeed noise or if it is infrared modulated transmission. If it is noise, it automatically changes the voltage reference level until it suppresses it. The process of noise suppression is continuous since the software repeatedly checks the level of voltage reference to ensure that noise will be kept at the established limit.

The software also manages the status indicator 9 and infrared activity indicators 10 of the system. The status and infrared activity indicators 9,10 may be LED lights. When the IRC receiver gets any kind of infrared signal, the software generates a fixed LED blinking indication at the infrared activity indicator 10. The activity indicator 10 will blink even if the signal is for a protocol with different carrier frequencies, which is not related to the carrier frequency and infrared protocol. When the microcontroller 5 processes the signal, it will trigger the infrared activity indicator 10 to acknowledge its reception of a signal by returning a flashing light pattern at the infrared activity indicator 10.

The status indicator 9 may be a LED light and is usually found on the receiver. The status indicator 9 is active or inactive based on the status of the device. Thus, the status indicator 9 shows whether the each particular device is powered. This alerts a user that it may be necessary to turn on a particular device, before any subsequent infrared commands will be registered by the system or receiver. This is particularly useful when operating a total remote control which can command many devices and where it may be unknown which devices are powered.

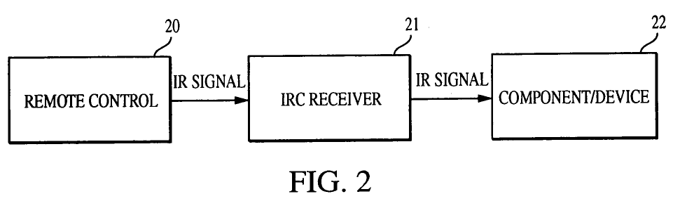

FIG. 2 is a signaling system overview which shows the IRC receiver used in a remote control application. At least one remote control 20 sends an infrared signal to the IRC receiver 21. The IRC receiver 21 processes the signal and determines if the signal is noise or a command. If the signal is determined to be a command, the IRC receiver 21 will emit a corresponding infrared signal to the component or device 22. If the signal is interpreted to be noise, the IRC receiver 21 will suppress the signal and not emit a corresponding signal to the component or device 22. An advantage of the invention is that the IRC receiver 21 will not process interfering signals, such as those received from a plasma television. The IRC receiver 21 will identify such signals from a plasma television as interference and suppress them.

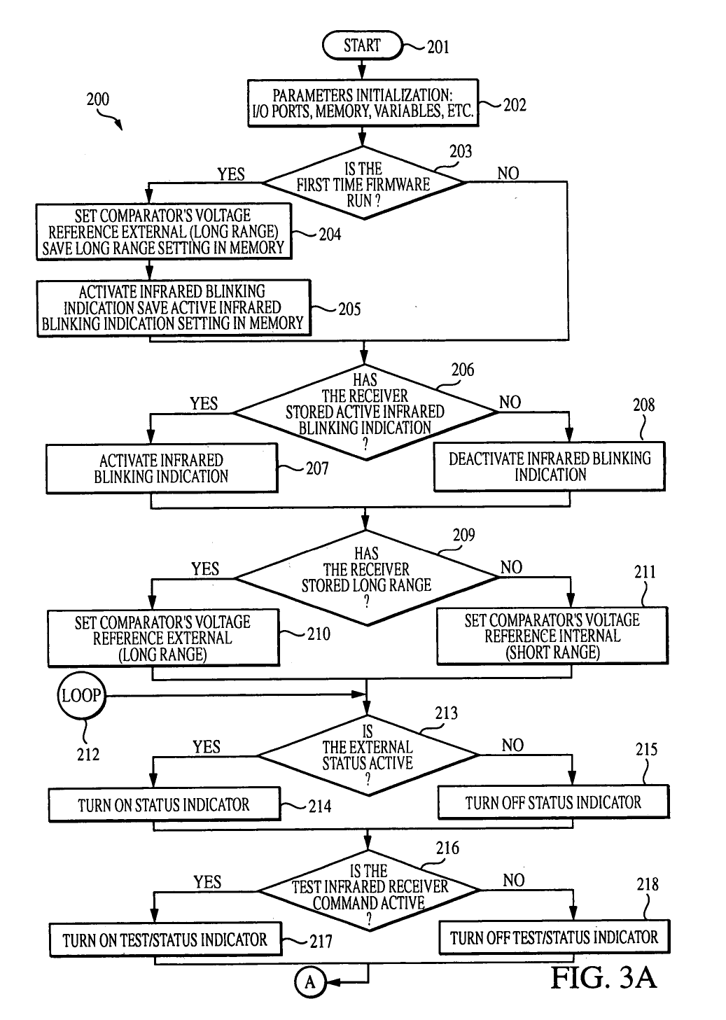

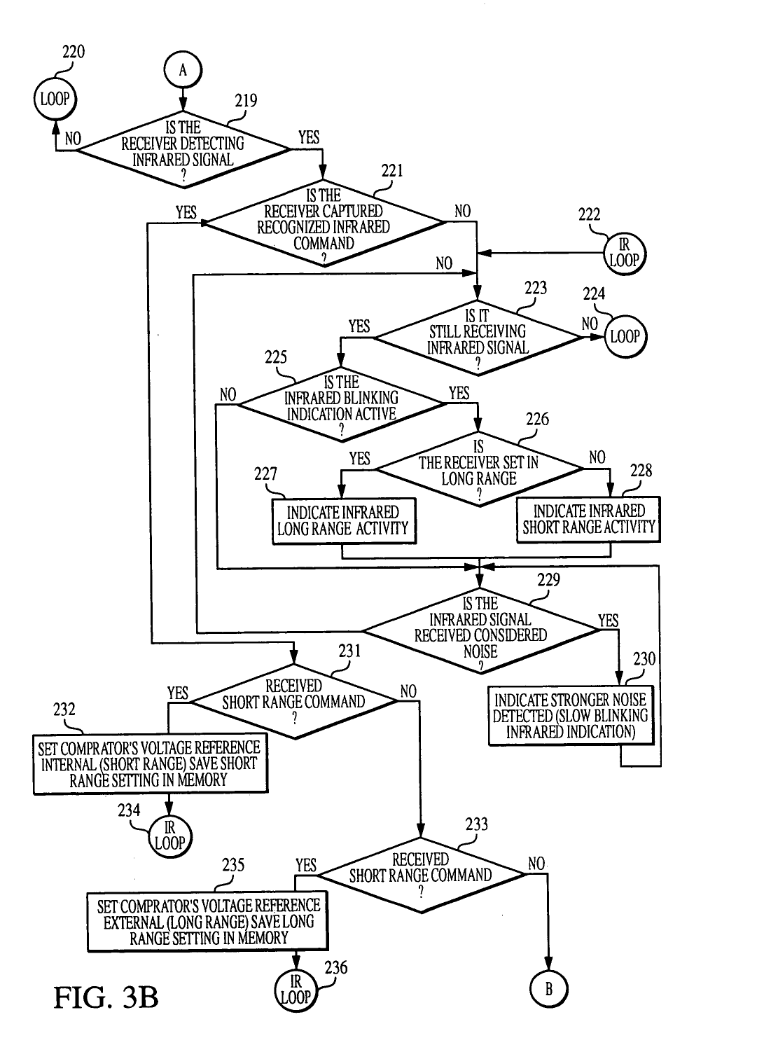

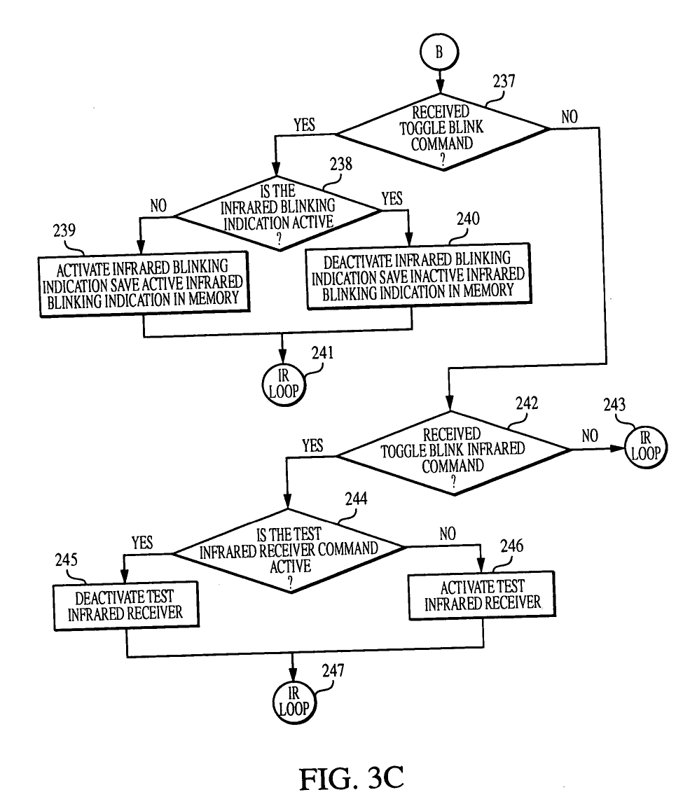

FIGS. 3A-3C are schematic flow diagrams of the IRC receiver and the method of setting appropriate reference voltage to suppress noise through the use of software within the microprocessor. The implemented software defines if the received signal is noise or if it is a recognized infrared modulated transmission from a remote control. If the software determines that the signal is noise, it automatically changes the voltage reference level until it suppresses it. The software continuously checks the level of voltage reference to ensure that noise will be kept at the established limit. The software is also responsible for activating the status indicators and the infrared activity indicator.

The method of processing infrared signals 200 includes starting the process 201 by parameter initialization 202 whereby the on/off ports, memory, variables, etc. are checked. The next step is to check whether it is the first time the firmware has been run 203. If it is the first time the firmware has been run, the comparator's voltage reference external (long range) is set and saved into the memory 204. Then the infrared blinking indication is activated and saved into the memory 205. The system then determines if the receiver has stored an active infrared blinking indication 206.

If, on the other hand, it is not the first time the firmware has run, then the system directly checks if the receiver has stored an active infrared blinking indication 206. If the receiver has stored an active infrared blinking indication 206, the system activates the infrared blinking indication 207. If the receiver has not stored an active infrared blinking indication 206, then the infrared blinking indication is deactivated 208. The process next checks if the receiver has stored long range 209. If the receiver has stored long range 209, then the comparator's voltage reference external (long range) is set 210. If the receiver has not stored long range 209, then the comparator's voltage reference internal (short range) is set 211. At this point in the pathway, later described loops re-enter the pathway at loop 212, whereby the system determines the external status.

The system then determines if the external status is active 213. If the external status is active, the status indicator is turned on 214. If the external status is not active, the status indicator is turned off 215. The system then proceeds to determine if the test infrared receiver command is active 216. If the test infrared receiver command is active, the test/status indicator is turned on 217. If the test infrared receiver command is inactive, the test/status indicator is turned off 218.

The pathway of the method of signal processing continues in FIG. 3B. The system determines if the receiver is detecting infrared signal 219. If the receiver is not detecting infrared signal, the system enters loop 220 whereby the system returns to the pathway at loop 212 to determine if the external status is active 213. If the receiver is detecting infrared signal 219, the system moves on to determine if the receiver captured a recognized infrared command 221. At this point in the pathway, IR loop 222 re-enters the pathway. If the receiver is receiving an infrared command, but it is not a recognized infrared command, the receiver determines if it is still receiving an infrared signal 223. If the receiver is no longer receiving an infrared signal, it enters loop 224 whereby the system returns to the pathway at loop 212 to determine if the external status is active 213. If the receiver is determines that it is still receiving an infrared signal, it checks to see if the infrared blinking indication is active 225. It the infrared blinking indication is active, the system checks to determine if the receiver is set in long range 226. If the receiver is set in long range, the receiver indicates infrared long range activity 227. If the receiver is not set in long range, the receiver indicates infrared short range activity 228.

When the infrared blinking indication is not active 225 or after the receiver has indicated either infrared long range activity 227 or infrared short range activity 228, the system determines whether the infrared signal received is considered noise 229. If the infrared signal is not considered noise, then the system returns to check if it is still receiving infrared signal 223. If the infrared signal received is considered noise 229, the receiver indicates stronger noise has been detected 230 by a slow blinking infrared light. After indicating a stronger noise has been detected 230, the system returns to determine if the infrared signal received is considered noise 229. Thus, this loop continues until an infrared signal is not longer detected.

If the receiver determines that the captured infrared command is a recognized command 221, the system checks if it has received a short range command 231. If the receiver has received a short range command, the comparator's voltage reference internal (short range) is set and saved into the memory 232. After setting and saving the comparator's voltage reference internal (short range) 232, the system enters an IR loop 234 whereby the system returns to the pathway at loop 222 to determine if the receiver is still receiving an infrared signal 223. If the receiver has not received a short range command 231, the system determines if it has received a long range command 233. If the receiver has received a long range command the comparator's voltage reference external (long range) is set and saved into the memory 235. The system then enters an IR loop 236 whereby the system returns to the pathway at loop 222 to determine if the receiver is still receiving an infrared signal 223. If the receiver has not received a long range command 233, the system determines if it has received a toggle blink command 237.

The pathway of the method of signal processing continues in FIG. 3C. If the system has received a toggle blink command 237, the receiver determines if the infrared blinking indication is active 238. If the infrared blinking indication is not active, the receiver activates the infrared blinking indication and saves the active infrared blinking indication into the memory 239. If the infrared blinking indication is active, the system deactivates the infrared blinking indication and saves the inactive infrared blinking indication into the memory 240. After the system has either activated or inactivated the infrared blinking indication and set and saved it into memory 239, 240, they system returns to an IR loop 241 whereby the system returns to the pathway at loop 222 to determine if the receiver is still receiving an infrared signal 223. If, on the other hand, the system determines it has not received a toggle blink command 237, the system determines if has received a toggle test infrared command 242. If the receiver has not received a toggle test infrared command 242, the system enters an IR loop 243 whereby the system returns to the pathway at loop 222 to determine if the receiver is still receiving an infrared signal 223.

If the system determines that it has received a toggle test infrared command 242, the system moves on to determine if the test infrared receiver command is active 244. If the test infrared receiver command is active, the system deactivates the test infrared receiver 245. If the test infrared receiver command is not active, the system activates the test infrared receiver 246. After the system either activates or deactivates the test infrared receiver 245 or 246, the system enters the IR loop 247 whereby the system returns to the pathway at loop 222 to determine if the receiver is still receiving an infrared signal 223.

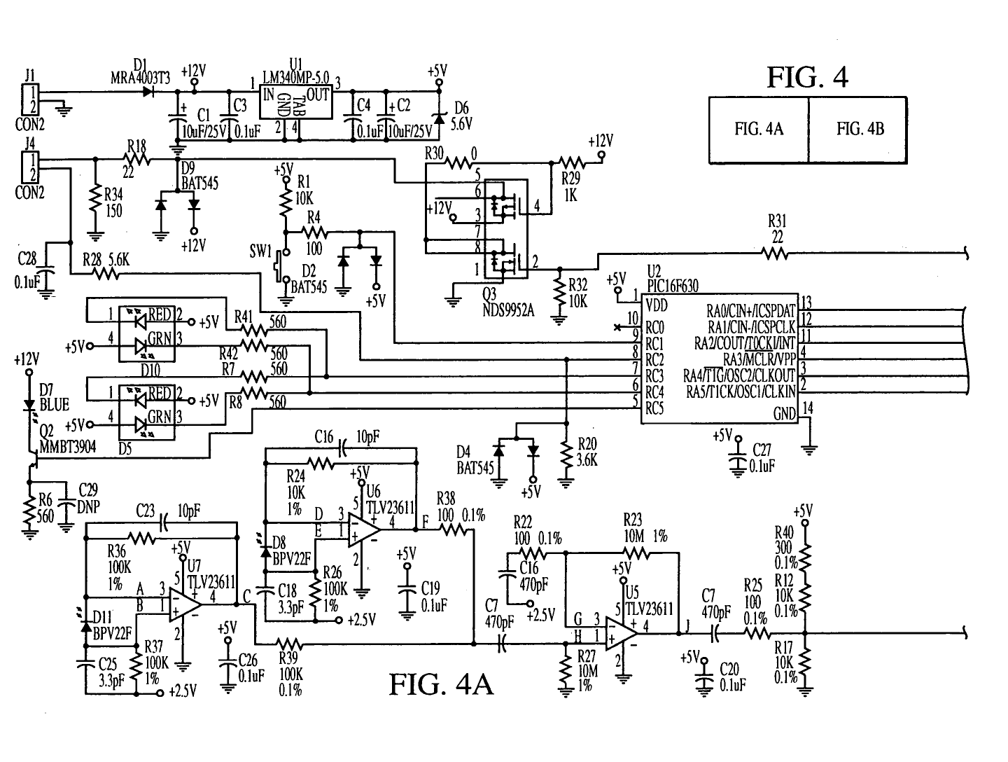

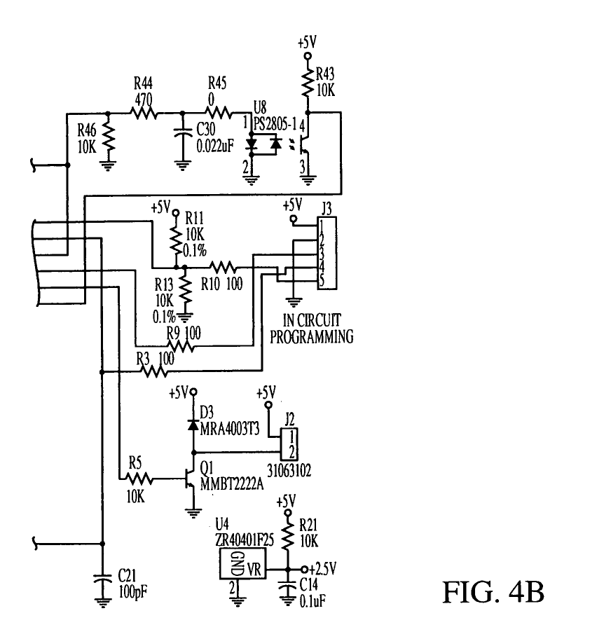

Now referring to FIG. 4, a schematic diagram is shown representing the circuit of the IRC receiver. The circuit of FIG. 4 contains two amplifiers U7 and U6. Each amplifier U7 and U6 contains a pair of capacitors C23, C25, C18, and C15; a photosensitive diode D11 and D8; resistors R37, R26, R36 and R24; a 5 volt cathode; and a ground connection. Between the two amplifiers U7 and U6 lies a resistor R39. The third amplifier U5 is found next in the circuit. It contains a capacitor C16, resistors R22 and R23, a 5 volt cathode and a ground connection. Between the third amplifier U5 and the first two amplifiers U7 and U6 is capacitor C17, resistor R27 and a ground connection.

Connecting the above series of amplifiers U7, U6 and US in the circuit is a connection to the microcontroller U2. The connection contains capacitors C7 and C21, a resistor R25 and a ground connection. Leading across this connection is a 5 volt cathode leading into resistors R12 and R17 and a ground connection. Also connecting to the microcontroller U2 is logic or switching interface circuit J2. Logic or switching interface circuit J2 receives a 5 volt cathode and connects to a photosensitive diode D3, which also receives a 5 volt cathode and a ground connection. Before connecting to the microcontroller U2, there is a resistor R5.

Also connecting to the microcontroller U2 is logic or switching interface circuit J3, which provides for in circuit programming. The logic or switching interface circuit J3 receives a 5 volt cathode and has a ground connection. Between the logic or switching interface circuit J3 and one of its connections to the microcontroller U2 is a resistor R9. Between the logic or switching interface circuit J3 and the other connection to the microcontroller U2 are resistors R10, R11, and R13, a 5 volt cathode and a ground connection. The logic or switching interface circuit J3 also connects to the amplifier connection after resistor R3.

The microcontroller U2 leads to several photosensitive diodes D4, D7, D5, D10, D2, D9, D1 and D6. Diodes D7, D10 and D5 serve as status and infrared activity indicators. Between diode D7 and the microcontroller U2 are resistors R33 and R6 and a ground connection. A 12 volt cathode leads into the diode D7. Two connections lead to diodes D5 and D10 from the microcontroller U2. Between diodes D5, D10 and the microcontroller U2 are resistors R7 and R8. Diodes D5 and D10 have a red and green light. Each light connects to a 5 volt cathode. The microcontroller U2 also connects to diodes D2. A 5 volt cathode leads into a diode D2 and is connected to another diode D2, which is ground connected. Connected to the diodes D2 are two resistors R4 and R1, a 5 volt cathode and a switch leading to a ground connection.

A completely connected circuit leads both into and out of the microcontroller U2. The connection contains the input and output amplifier control Q3, diodes and a logic or switching interface circuit J4. Between the microcontroller U2 and the input and output amplifier control Q3 are resistors R31, R32 and a ground connection. The input and output amplifier control Q3 contains diodes, 12 volt cathodes, resistors R30 and R2 and a ground connection. The input and output amplifier control Q3 is connected to diodes D9. A 5 volt cathode leads into a diode D9 and is connected to another diode D9, which is ground connected. The diodes D9 are connected to a logic or switching interface circuit J4. Between the logic or switching interface circuit J4 and diodes D9 are resistors R18 and R34 and a ground connection. Logic or switching interface circuit J4 connects back to the microcontroller U2 with resistors R28, R20 and diodes D4 between the components. A 5 volt cathode leads into a diode D4 and is connected to another diode D4, which is ground connected.

The logic or switching interface circuit J1 connects to diodes D1 and D6 and a power supply regulator U1. The logic or switching interface circuit J1 also connects to a ground connection. A series of capacitors C1, C3, C4 and C2 connect logic or switching interface circuit J1 to the power supply regulator U1. A 12 volt and a 5 volt cathode are found in this circuit as well as a ground connection. Separately found on the circuit board are mounting holes MH1 and MH3 connected to a grounded shield and a ground connection. Also separately found on the circuit board is microcontroller U4 which contains a 5 volt cathode, a resistor R21, a 2.5 volt cathode, a capacitor C14 and two ground connections. Three separate amplifiers U7A, U6A and USA are also found on the circuit board. These amplifiers each connect to a 5 volt cathode, and a ground connection.

It is possible to use a simpler circuit with the infrared remote control receiver, while retaining the desired functions of the invention. For example, a circuit could be limited to containing a series of amplifiers, the microcontrollers, a status diode, and an activity indicator diode connected to input and output amplifier controls. The circuitry should be designed around the desired functions of the infrared remote control receiver.

Accordingly, it will be understood that the preferred embodiment of the present invention has been disclosed by way of example and that other modifications and alterations may occur to those skilled in the art without departing from the scope and spirit of the appended claims.

1. An infrared remote control receiver with improved noise suppression comprising:
an optional optical magnifier;
an interference filter;
at least one pin photodiode;
an input amplifier;
a microcontroller;
an output amplifier;
an output port; and
a power supply regulator.

2. The receiver of claim 1, further including an infrared activity indicator.

3. The receiver of claim 2, wherein said infrared activity indicator indicates whether said receiver is receiving a signal by activation of a LED.

4. The receiver of claim 2, wherein said infrared activity indicator may be deactivated after installation.

5. The receiver of claim 1, further including a status indicator that indicates whether each device within a system is powered.

6. The receiver, of claim 1, wherein said optical magnifier is a lens.

7. The receiver of claim 1, wherein said interference filter is a bandpass glass interference filter.

8. The receiver of claim 7, wherein said bandpass glass interference filter ranges from about 950+/−12.5 nanometers to about 950+/−20 nanometers.

9. The receiver of claim 1, wherein said at least one pin photodiode comprises a radiant sensitive area of about 7.5 square millimeters.

10. The receiver of claim 1, wherein said input amplifier uses a high impedance and an overall high gain.

11. The receiver of claim 10, wherein said input amplifier increases the amplitude of a signal with an infrared carrier frequency from about 20 kilohertz to about 110 kilohertz.

12. The receiver of claim 1, wherein said microcontroller comprises a comparator and a voltage reference, wherein said microcontroller compares a background noise with a possible infrared modulated transmission by using threshold control.

13. The receiver of claim 1, wherein said microcontroller determines if a signal is noise or if it is an infrared modulated transmission and if said signal is noise said microcontroller changes a voltage reference level until said noise is suppressed.

14. The receiver of claim 1, wherein said output amplifier comprises a metal-oxide-silicon field-effect transistor.

15. The receiver of claim 1, wherein said output port emits a modulated infrared signal to a device or component to control said device or component.

16. The receiver of claim 1, wherein said power supply regulator holds power at a constant value.

17. The receiver of claim 1, wherein said noise suppression includes interference from plasma television displays and fluorescent light.

18. A front end of an infrared remote control receiver useful for capturing a signal and suppressing unwanted signals or interference comprising:
an optional optical magnifier;
a interference filter;
at least one pin photodiode;
an input amplifier;
a microcontroller; and
an output amplifier.

19. The front end of claim 18, wherein said optical magnifier is a lens.

20. The front end of claim 18, wherein said interference filter is a bandpass glass interference filter.

21. The front end of claim 20, wherein said bandpass glass interference filter ranges from about 950+/−12.5 nanometers to about 950+/−20 nanometers.

22. The front end of claim 18, wherein said at least one pin photodiode comprises a radiant sensitive area of about 7.5 square millimeters.

23. The front end of claim 18, wherein said input amplifier comprises a high impedance and an overall high gain.

24. The front end of claim 23, wherein said input amplifier amplifies signals with an infrared carrier frequency from about 20 kilohertz to about 110 kilohertz.

25. The front end of claim 18, wherein said microcontroller comprises a comparator and a voltage reference, wherein said microcontroller compares a background noise with a possible infrared modulated transmission by using threshold control.

26. The front end of claim 18, wherein said output amplifier comprises a metal-oxide-silicon field-effect transistor.

27. The front end of claim 18, wherein said unwanted signals or interference includes interference from plasma television displays and fluorescent light.

28. A method of processing an infrared signal by an infrared remote controller receiver comprising the steps of:
receiving a signal;
measuring a background noise;
determining if said signal is said background noise or said infrared signal;
changing a voltage reference level if said signal is determined to be said background noise; and
repeating said steps to ensure said background noise is kept at an established limit.

29. The method of claim 28, further including the step of generating an indication of receipt of said infrared signal at an infrared activity indicator.

30. The method of claim 29, wherein the step of generating an indication of receipt of said infrared signal at an infrared activity indicator includes the step of activating at least one predetermined visual signal through at least one light source.

31. The method of claim 28, further including the step of generating an indication of status of each component connected to said receiver.

32. The method of claim 30, wherein the step of generating an indication of status of each component connected to said receiver includes the step of activating at least one predetermined visual signal through at least one light source.

33. An infrared remote control receiver circuit wherein the receiver differentiates background noise from an infrared signal and suppresses said background noise, said circuit comprising:
a series of amplifiers;
at least one microcontroller;
at least one status diode;
an activity indicator diode;
an input and output amplifier control;
wherein software within said microcontroller compares said background noise with said infrared signal; and
wherein the voltage reference level is changed if said signal is determined to be said background noise.

34. The infrared remote control receiver of claim 33, wherein said circuit generates an indication of receipt of said infrared signal at said activity indicator.

35. The infrared remote control receiver of claim 33, wherein said circuit generates an indication of receipt of said infrared signal at said activity indicator by activating at least one predetermined visual signal through at least one light source.

36. The infrared remote control receiver of claim 33, wherein said circuit generates an indication of status of each component connected to said receiver.

37. The infrared remote control receiver of claim 33, wherein said circuit generates an indication of status of each component connected to said receiver by activating at least one predetermined visual signal through at least one light source.

38. The receiver of claim 10, wherein said input amplifier increases the amplitude of a signal without a carrier frequency.

39. The front end of claim 23, wherein said input amplifier amplifies a signal without a carrier frequency.

40. The receiver of claim 1, wherein said receiver is capable of processing an infrared signal with a carrier frequency and an infrared signal without a carrier frequency.

41. The front end of claim 18, wherein said front end is capable of processing an infrared signal with a carrier frequency and an infrared signal without a carrier frequency.
